(19) United States
(12) Patent Application Publication
(10) Pub. No.: US 2026/0050822 A1
(43) Pub. Date: Feb. 19, 2026

(54) DETECTING SUSPICIOUS ACTIVITY USING BAYESIAN NETWORKS

(71) Applicant: Oracle International Corporation, Redwood Shores, CA (US)

(72) Inventor: Govind Gopinathan Nair, Jersey City, NJ (US)

(73) Assignee: Oracle International Corporation, Redwood Shores, CA (US)

(21) Appl. No.: 18/807,417

(22) Filed: Aug. 16, 2024

(51) Int. Cl. G06N 20/00; G06N 7/01

(52) U.S. Cl. CPC G06N 20/00; G06N 7/01

(57) ABSTRACT

Method includes: configuring ML model to be associated with parameters, for monitoring suspicious event, ML model including BN including nodes, each respectively associated with parameter and including set of values corresponding to parameter; capturing data associated with interactions of customers included in segment; identifying, based on rules, events associated with focal entity corresponding to at least one customer of segment, where suspicious event is indicative that focal entity potentially violated rule; inputting event data corresponding to suspicious event to ML model; outputting by ML model output result including probability prediction of focal entity involvement in suspicious event, probability with which focal entity violated each red flag that the rule is configured to detect, and description of activity that caused violation of the red flag; detecting signal corresponding to user input; and updating ML model by updating a value of set of values associated with a parameter associated with red flag.

### FIELD

The present disclosure relates generally to artificial intelligence (AI) techniques, and, more particularly, to improved techniques for detecting and quantifying suspicious events in the customer interactions with the online network system, and identifying and quantifying factors that contribute to the detection of the suspicious events.

### BACKGROUND

Generally, online network interactions can be detected and classified based on various parameters and applications. For example, some systems may be tasked with monitoring the online network traffic and detect suspicious interactions of a customer with the online networks systems.

One monitoring technique is generally rule-based system. The rule-based systems mainly rely on expert knowledge to set up the rules. Because such techniques are rule-based, they are non-dynamic and hard to update. Also, in this technique, the provided output is 0 or 1, e.g., unsuspicious activity vs. suspicious activity, where the alert is provided in the case of suspicious activity and the case is generated for review by the analyst. However, because provided output is rigid, there is no indication regarding the degree to which the individual is involved in the suspicious activity.

Other techniques employ the machine-learning (ML) models. However, the ML models need to be trained on a large corpus of labeled data, e.g., thousands of labeled samples of instances of suspicious activity. The training data that includes training examples of suspicious activity is scarce. Thus, although the ML model can provide the probabilistic output regarding the degree of the suspicious activity, the use of the ML models remains challenging because of the lack of training data. Further, similarly to the rule-based approach, it is very difficult to implement timely updates.

Additionally, the current systems and methods cannot provide a meaningful explanation about what factors contributed to the case being generated.

Therefore, improved techniques are needed.

### SUMMARY

Techniques disclosed herein relate generally to artificial intelligence (AI) techniques, and, more particularly, to improved techniques for detecting and quantifying suspicious events in the customer interactions with the online network system, and identifying and quantifying factors that contribute to the detection of the suspicious events.

In various embodiments, a computer-implemented method is provided that includes configuring a machine learning (ML) model to be associated with a set of parameters, for monitoring a suspicious event of a plurality of suspicious events, the ML model including a Bayesian network (BN) constructed as a tree structure including nodes, each node being respectively associated with a parameter of the set of parameters and including a set of values corresponding to the parameter, where at least some parameters of the set of parameters respectively correspond to red flags; capturing data associated with interactions of a set of customers included in a segment; identifying, based on the plurality of rules, the suspicious event associated with a focal entity corresponding to at least one customer of the segment, where the suspicious event is indicative that the focal entity potentially violated a rule of a plurality of rules; inputting event data corresponding to the suspicious event to the ML model; outputting by the ML model an output result including (1) a probability prediction with respect to the focal entity being involved in the suspicious event, (2) a probability with which the focal entity violated each of one or more red flags that the rule is configured to detect, and (3) a description of an activity that caused a violation of the one or more red flags, with respect to the focal entity; in response to the output result, detecting a signal corresponding to a user input provided by a user through a user interface; and in response to the signal, updating the ML model, the updating including updating at least one value of the set of values associated with at least one parameter of the at least some parameters, at least one parameter being associated with the one or more red flags.

In some embodiments, the ML model is a probabilistic graph model.

In some embodiments, the outputting includes displaying a report on a display of a user device, for the user to identify that an update of the ML model is to be performed.

In some embodiments, a plurality of ML models is configured, each of the plurality of ML models being configured to monitor for a certain suspicious event among the plurality of suspicious events, the ML model being one of the plurality of ML models.

In some embodiments, each ML model of the plurality of ML models is configured as a BN constructed as a tree structure of a certain architecture including nodes associated with a certain set of parameters particular to each ML model, to monitor the certain suspicious event among the plurality of suspicious events.

In some embodiments, each node of each ML model stores a set of values associated with the certain set of parameters.

In some embodiments, the ML model is continually updated.

In various embodiments, a computer system is provided that includes one or more processors and one or more computer-readable media storing instructions that, when executed by the one or more processors, cause the one or more processors to perform part or all of the operations and/or methods disclosed herein.

In various embodiments, one or more non-transitory computer-readable media are provided, the one or more non-transitory computer-readable media storing instructions that, when executed by one or more processors of a computer system, cause the one or more processors to perform part or all of the operations and/or methods disclosed herein.

The techniques described herein may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a suspicious activity detection system according to various embodiments.

FIG. 2 is a simplified block diagram of a Bayesian network according to various embodiments.

FIG. 3 is a simplified block diagram of a suspicious activity detection system in a distributed computing environment according to various embodiments.

FIG. 4 is a simplified block diagram of a suspicious activity detection system in a cloud service provider (CSP) infrastructure according to various embodiments.

FIG. 5 is a simplified block diagram of a processing performed by the suspicious activity detection system in accordance with various embodiments.

FIG. 6 depicts a simplified diagram of a distributed system for implementing various embodiments.

FIG. 7 is a simplified block diagram of one or more components of a system environment by which services provided by one or more components of an embodiment system may be offered as cloud services, in accordance with various embodiments.

FIG. 8 illustrates an example computer system that may be used to implement various embodiments.

### TERMS

Prior to further describing embodiments of the disclosure, description of related terms is provided.

A “user” can be a person or thing that employs some other thing for some purpose. A user may include an individual that uses a user device and/or a website. The user may also be referred to as a “consumer” or “customer” depending on the type of the website.

A “user device” may include any suitable computing device that can be used for communication. A user device may also be referred to as a “communication device.” A user device may provide remote or direct communication capabilities. Examples of remote communication capabilities include using a mobile phone (wireless) network, wireless data network (e.g., 3G, 4G, 5G, or similar networks), Wi-Fi, Wi-Max, or any other communication medium that may provide access to a network such as the Internet or a private network. Examples of user devices include desktop computers, mobile phones (e.g., cellular phones), PDAs, tablet computers, net books, laptop computers, etc. Further examples of user devices include wearable devices, such as smart watches, fitness bands, ankle bracelets, etc., as well as automobiles with remote or direct communication capabilities. A user device may include any suitable hardware and software for performing such functions, and may also include multiple devices or components (e.g., when a device has remote access to a network by tethering to another device—i.e., using the other device as a modem-both devices taken together may be considered a single communication device).

A “server computer” may include a powerful computer or cluster of computers. For example, the server computer can be a large mainframe, a minicomputer cluster, or a group of computers functioning as a unit. In some cases, the server computer may function as a web server or a database server. The server computer may include any hardware, software, other logic, or combination of the preceding for servicing the requests from one or more other computers. The term “computer system” may generally refer to a system including one or more server computers.

A “processor” or “processor circuit” may refer to any suitable data computation device or devices. A processor may include one or more microprocessors working together to accomplish a desired function. The processor may include a CPU that includes at least one high-speed data processor adequate to execute program components for executing user and/or system-generated requests. The CPU may be a microprocessor such as AMD's Athlon, Duron and/or Opteron, etc.; IBM and/or Motorola's PowerPC; IBM's and Sony's Cell processor; Intel's Celeron, Itanium, Pentium, Xeon, and/or Xscale, etc.; and/or the like processor(s).

A “memory” or “system memory” may be any suitable device or devices that can store electronic data. A suitable memory may include a non-transitory computer readable medium that stores instructions that can be executed by a processor to implement a desired method. Examples of memories may include one or more memory chips, disk drives, etc. Such memories may operate using any suitable electrical, optical, and/or magnetic mode of operation.

In this disclosure, the term “customer interactions,” “user interactions,” or “interactions” relates generally to any interaction of the customer or the user with the online network system.

The term “machine learning model” may refer to a program, file, method, or process, used to perform some function on data, based on knowledge “learned” during a training phase. For example, a machine learning model can be used to classify feature vectors as normal or anomalous. In “supervised learning,” during a training phase, a machine learning model can learn correlations between features contained in feature vectors and associated labels. After training, the machine learning model can receive unlabeled feature vectors and generate the corresponding labels. For example, during training, a machine learning model can evaluate labeled images of dogs, then after training, the machine learning model can evaluate unlabeled images, in order to determine if those images are of dogs. In “unsupervised learning,” an ML model or algorithm is provided with unlabeled data, and is tasked to analyze and find patterns in the unlabeled data.

Example supervised learning models may include different approaches and algorithms including analytical learning, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, statistical relational learning, or Proaftn, a multicriteria classification algorithm.

The models may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), etc. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Machine learning models may be defined by “parameter sets,” including “parameters,” which may refer to numerical or other measurable factors that define a system (e.g., the machine learning model) or the condition of its operation. In some cases, training a machine learning model may include identifying the parameter set that results in the best performance by the machine learning model. This can be accomplished using a “loss function,” which may refer to a function that relates a model parameter set to a “loss value” or “error value,” a metric that relates the performance of a machine learning model to its expected or desired performance.

Bayesian networks (BN) are a fundamental concept in artificial intelligence (AI) that use probability to represent a set of variables and their conditional dependencies. They are also known as belief networks, Bayes nets or networks, or decision networks. Bayesian networks are represented by a directed acyclic graph (DAG) made up of nodes and directed edges. Each node represents a random variable, and the edges show the dependencies between the variables. Bayesian networks can be built from data or expert opinion, and can be used for a variety of tasks, including diagnostics, reasoning, causal modeling, decision making under uncertainty, anomaly detection, automated insight, and prediction. A key characteristic of Bayesian networks is their ability to predict the likelihood of different known causes contributing to an event that has already occurred. For example, a Bayesian network could represent the probabilistic relationships between diseases and symptoms. Given symptoms, the Bayesian network can be used to compute the probabilities of the presence of various diseases.

The term “providing” may include sending, transmitting, displaying or rendering, making available, or any other suitable method. While not necessarily described, messages communicated between any of the computers, networks, and devices described herein may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

Sanctions lists are lists of persons and entities subject to comprehensive or targeted restrictive measures under international and domestic sanctions regimes. People and entities are added to these lists for various reasons, including having links to terrorism, terrorist financing, the proliferation of weapons of mass destruction, arms trafficking, narco-trafficking or war crimes.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. INTRODUCTION

Techniques disclosed herein relate generally to artificial intelligence (AI) techniques, and, more particularly, to improved techniques for detecting and quantifying suspicious events in the customer interactions with the online network system, and identifying and quantifying factors that contribute to the detection of the suspicious events. For example, the online network system may include a financial network system.

Generally, network interactions can be detected and classified based on various parameters and applications. For example, some systems may be tasked with monitoring the online network traffic and detect suspicious interactions with respect to the interaction data corresponding to a segment.

In certain implementations, a segment may correspond to a set of customers, where the set of customers can include customers associated with one or more similar characteristics. For example, the segment can include customers associated with the same account, the same business or external entity, e.g., a financial institution, etc. As for other examples, the segment can be associated with one or more characteristics among a geographic location, a use of a certain currency, an age of the customers, a known involvement in a category of the suspicious or criminal activity, a transaction count per day exceeding a certain limit, a transaction amount per day exceeding certain limit, and the like.

The suspicious event may indicate an instance of a customer or a group of customers of a segment being potentially involved in the suspicious activity, e.g., an instance where a customer or a group of customers violate one or more rules associated with detecting the suspicious activity. Herein, the suspicious event may indicate an instance of terrorist financing, sanctions violations, etc. The suspicious event may be associated with a focal entity within the segment, where the focal entity may be a customer within the segment, at least a part of the customers within the segment, an account associated with the segment, etc.

In the rule-based approach, the interaction monitoring system may include rules and/or scenarios that are chosen by an entity to mitigate the risks (e.g., money-laundering risks) that the entity is exposed to. Generally, the entity is aware of the risks associated with certain customers to monitor for certain suspicious or criminal activity, e.g., terrorist financing, sanctions violations, etc. The entities lay out a theory around what the risks are and hypothesize the controls that are best suited for mitigating these risks. For example, the entity can first identify the relevant risks the entity, e.g., a financial institution, is exposed to given its customer base, product portfolio, and geography, and then select rules and/or scenarios to monitor the online network interactions, where the system is capable of detecting known risks.

As a non-limiting example, the rules directed to human trafficking can specify one or more of the following: (1) a number of wire transfers exceeding a threshold number of wire transfers in a predetermined time period, (2) a cash deposit exceeding a threshold amount, (3) a number of payments with no apparent business purpose from multiple originators from different geographic locations either across the (a) US or (b) Mexico and Central America, to one beneficiary located on or around the South West border. A scenario may be a combination of rules or a single rule.

The rules and scenarios suitable for detecting other suspicious activities can be similarly expressed with regard to the specifics particular to each suspicious activity.

Herein, the terms “rule” and “scenario” can be used in some instances interchangeably depending on context.

With respect to entity executing monitoring, the monitoring can be specified as one or more rules and/or scenarios with respect to the geographic area, products involved, etc. The rules can include rules on the parameters related to the total transactions made by the customer over the time period, e.g., the total credit amount, the total debit amount, the total credit count, debit count, etc. For example, the rule can specify that when a certain parameter exceeds a threshold, the alert is triggered, where the threshold may be set higher for a low risk customer (e.g., a transaction amount is greater than $25,000) and lower for a high risk customer (e.g., a transaction amount is greater than $5,000). An example of a scenario may be if a total transaction amount is greater than $25,000 and a total transaction count is greater than 5, then trigger an alert.

The entity computer system can monitor the data associated with the interactions by the customers of the segment and aggregate information over a period of time based on rules and/or scenarios, where the cases are created based on the alerts and provided to a user for review, e.g., an analyst who analyzes the alerts.

However, the rule-based approach described above is problematic. First, the scenarios and rules are not set up entirely impartial since they are set up based on somebody's judgment. Second, in this technique, the provided output is 0 or 1, e.g., unsuspicious activity vs. suspicious activity, where alert is provided in the case of suspicious activity. Because such output is rigid, there is no indication regarding the degree to which the individual is involved in the suspicious activity. Further, this approach is not flexible. Once the rules are set up, it is very difficult to implement timely updates, as, for example, in the situation when a customer is proven to not be involved in the terrorist financing.

In another approach, the machine learning (ML) models based on neural networks can be used. The ML models need to be trained on a large corpus of labeled data, e.g., thousands of labeled samples of instances of suspicious activity. However, the training data that includes training examples of suspicious activity is scarce. Thus, although the ML model can provide the probabilistic output regarding the degree of the suspicious activity, the use of the ML models remains challenging because of the lack of training data. Further, similarly to the approach described above, it is very difficult to implement timely updates. For example, the data needs to be collected for a time period, e.g., 6 months, before the update can be implemented.

Additionally, in both approaches mentioned above, no meaningful explanation or supporting context is provided regarding the cause of the alert. For example, the explanation provided by the current techniques may be “the behavior of the entity changed.” This is a poor explanation for a suspicious activity, as a change in behavior could be because someone sold their car or their house. For example, a more meaningful explanation for suspicious activity may be, “the online interactions are not commensurate with the stated business type and/or unusual and unexpected in comparison with the volumes of similar businesses operating in the same locale.”

Thus, the current approaches are resource intensive because, given poor explanation of potentially suspicious activity, the analyst or investigator needs to extensively investigate each suspicious event by using a computer system to investigate the interaction data, and then to describe which specific events and circumstances caused the case to be generated (e.g., one or more alerts to trigger).

Accordingly, different techniques are needed to address these challenges and others.

The disclosed techniques use a Bayesian network (BN) to build an improved monitoring and detection system that provides a probabilistic estimate of a party being a risk based on the prior knowledge for different risk-based segments.

The disclosed techniques provide for taking into consideration information from multiple external sources such as custom risk assessments, negative news, sanctions, external risks, etc., and outputting a consolidated risk score. Additionally, in an embodiment, one or more additional new external sources can be added. Likewise, one or more of the existing external sources can be deleted.

In the disclosed techniques, the ML model is a probabilistic graphical model and is capable of providing a detailed and meaningful explanation and/or contextual information why the case is generated. This is in contrast to the related art techniques using the neural network models that are not capable of providing meaningful explanation and/or contextual information why the alert is triggered and/or case is generated.

The use of the probabilistic graphical model in the disclosed techniques allows to get started with only a small amount of data (e.g., a set of parameters) and learn from available labels on the efficacy of rules as well as the quality of red flags (e.g., alerts). This is in contrast to the related art techniques where the ML models require a large labeled corpus of data to be trained. Thus, the disclosed techniques improve functioning of the computer systems and networks by not requiring large resources for model training and not requiring large storage capacity for the labeled training data and results. Additionally, there is no need to collect, analyze, and/or store large amounts of customer data to update the model parameters. The update can be done almost instantaneously. As such, the model is continuously learning based on the feedback, and updates happen frequently using small incremental additions or reductions, thus requiring very limited computing resources. As such, the suspicious activity monitoring system of the disclosed technique is kept current with timely updates that use the most recent customer information without requiring a substantial change to the system and subsequent testing, and/or retraining of the model.

In various embodiments, a machine learning (ML) model is configured to be associated with a set of parameters for monitoring a suspicious event or a plurality of a suspicious events, as a Bayesian network (BN) constructed as a tree structure including nodes. Each node of the BN is associated with a parameter of the set of parameters and includes a set of values corresponding to the parameter, where at least some parameters of the set of parameters correspond to red flags and scenarios. Based on the plurality of rules, the suspicious event can be identified in the interaction data corresponding to the segment. The suspicious event is indicative that the focal entity of the segment potentially violated a rule of the plurality of rules. The event data corresponding to the suspicious event is input to the ML model, where the ML model performs a certain processing based on the event data. As a result of the processing, the ML model can provide an output result including (1) a probability prediction with respect to the focal entity being involved in the suspicious event, (2) a probability with which the focal entity violated each of the red flags that the rule is configured to detect, and (3) a description of an activity that caused determination of a violation of the red flags. Upon a user reviewing the output result, a user may provide a user input through a user interface to update the ML model. The user here means an analyst. The ML model then can be updated, by updating at least one value of the set of values associated with at least one parameter of the at least some parameters, at least one parameter being associated with at least one of the red flags and/or at least one of the scenarios.

### II. SUSPICIOUS ACTIVITY DETECTION SYSTEM

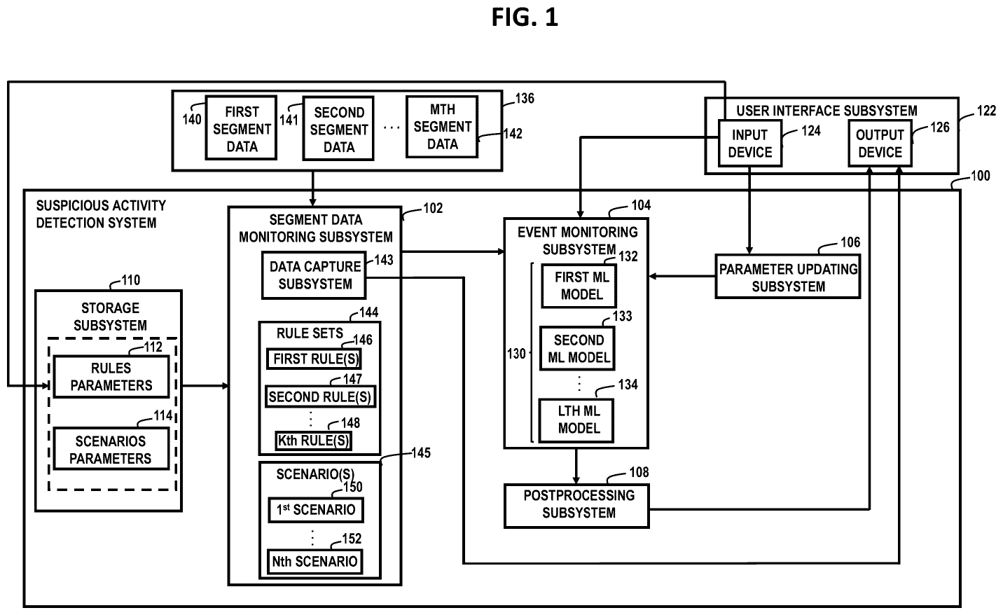

FIG. 1 is a simplified block diagram of a suspicious activity detection system 100 according to various embodiments. The suspicious activity detection system 100 may be implemented using one or more computer systems, each computer system having one or more processors. The suspicious activity detection system 100 may include multiple components and subsystems communicatively coupled to each other via one or more communication mechanisms. For example, in the embodiment depicted in FIG. 1, the suspicious activity detection system 100 includes a segment data monitoring subsystem 102, an event monitoring subsystem 104, a parameter updating subsystem 106, and a postprocessing subsystem 108.

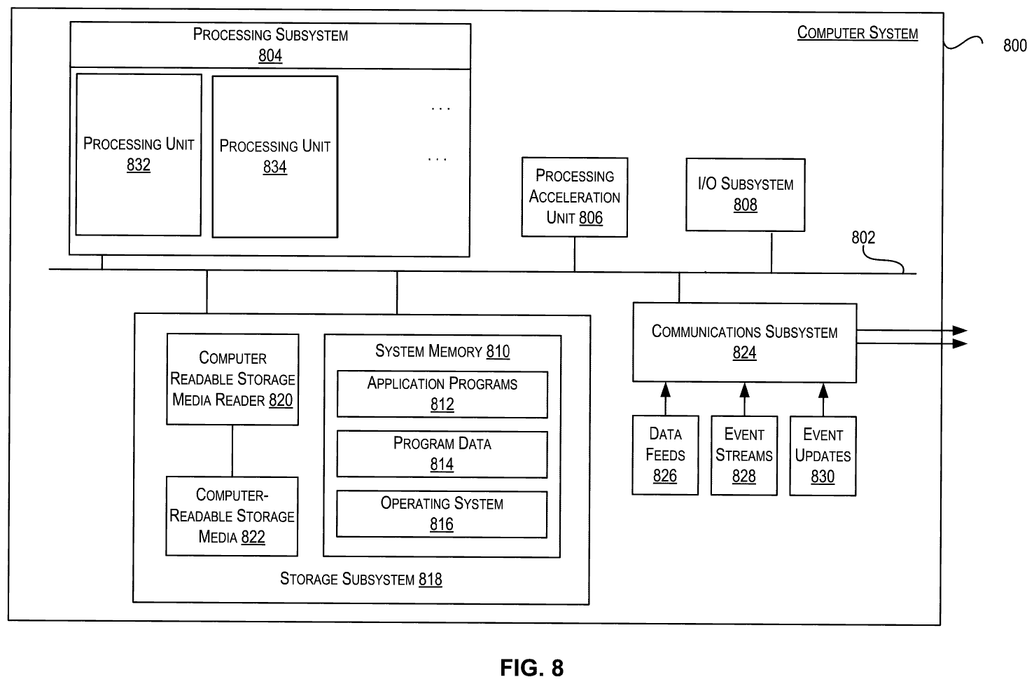

These subsystems may be implemented as one or more computer systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The suspicious activity detection system 100 depicted in FIG. 1 is merely an example and is not intended to unduly limit the scope of embodiments. Many variations, alternatives, and modifications are possible. For example, in some implementations, the suspicious activity detection system 100 may have more or fewer subsystems or components than those shown in FIG. 1, may combine two or more subsystems, or may have a different configuration or arrangement of subsystems. The suspicious activity detection system 100 and subsystems depicted in FIG. 1 may be implemented using one or more computer systems, such as the computer system depicted in FIG. 8.

As shown in FIG. 1, the suspicious activity detection system 100 also includes a storage subsystem 110 that may store the various data constructs and programs used by the suspicious activity detection system 100. For example, the storage subsystem 110 may store values for one or more parameter sets, e.g., rules parameters 112 and scenarios parameters 114. The rules parameters 112 and the scenarios parameters 114 may be used by the segment data monitoring subsystem 102 to monitor for one or more suspicious activities that may include human trafficking, drug trafficking, terrorist financing, elder abuse, money laundering, etc., as described in detail below.

The suspicious activity detection system 100 can further include a user interface (UI) subsystem 122 including one or more input devices 124 for receiving a user input. The UI subsystem 122 may be implemented in an electronic device such as a computer, a mobile phone, etc.

Although FIG. 1 illustrates only one input device 124, the UI subsystem 122 may include a plurality of input devices. The plurality of input devices may take any suitable form, e.g., buttons, keyboard, mouse, microphone, etc. The UI subsystem 122 may further include an output device 126 that may be a display screen. In some instances, the output device 126 may be a touch screen including a display screen for providing a display output and a touch pad serving as one of the input devices 124.

In embodiments, the suspicious activity detection system 100 is configured to detect the suspicious activity in interaction data 136 of a plurality of segments, where each of the plurality of segments includes customers, e.g., 10 million customers. The interaction data 136 may include transaction data.

The interaction data 136 can include a first segment data 140 to an Mth segment data 142, corresponding to a first segment to an Mth segment. As described above, a segment corresponds to a set of customers. The segment data may be referred to as a batch of records. Each batch of records may include a plurality of records, e.g., millions of records.

For example, the segment data monitoring subsystem 102 is configured to monitor the online network data (e.g., the interaction data 136) and generate events (e.g., cases) relating to the suspicious activity based on rules and/or scenarios. In an example below, the description is provided for monitoring the first segment data 140. However, any batch of records corresponding to a second segment data 141 to the Mth segment data 142 of the interaction data 136 can be similarly monitored.

With reference to FIG. 1, a data capture subsystem 143 may receive the first segment data 140. The first segment data 140 may include interaction data of the first segment, e.g., a first set of customers. In an example, the customers of the first segment are associated with a certain geographic area. In embodiments, the data capture subsystem 143 includes a plurality of models, each associated with particular rules and/or scenarios. For example, the data capture subsystem 143 can process the first segment data 140 based on rule sets 144 and/or scenarios 145.

The rule can specify that when a certain parameter exceeds a threshold, the alert is triggered, where the threshold may be set higher for a low risk customer (e.g., a transaction amount is greater than $25,000) and lower for a high risk customer (e.g., a transaction amount is greater than $5,000). An example of a scenario may be, if a total transaction amount is greater than $25,000 and a total transaction count is greater than 5, then trigger an alert.

The rules, scenarios, and values of the parameters for the rules and scenarios may be predefined and provided by a user via the UI subsystem 122 and, thus, are adjustable. As mentioned above, the values for the rules parameters 112 for the rules of the rule sets 144 and the values for the scenarios parameters 114 for the scenarios 145 may be stored in the storage subsystem 110.

Each of the rule sets 144 can be directed to a certain suspicious activity and can include one or more rules tailored to that suspicious activity. In certain implementations, two or more of the rule sets 144 can be directed to the same suspicious activity, some of the rule sets 144 can be directed to the suspicious activities different from each other, or each rule set of the rule sets 144 can be directed to a different suspicious activity.

The rule sets 144 can include a first set of rules or first rule(s) 146 and a second set of rules or second rule(s) 147 to a Kth set of rule(s) or Kth rules 149. A number of rule sets is not limited and can be 2, . . . , 8, . . . , 15, etc.

As an example, the first rule(s) 146 can include rules directed to the terrorist activity. The violation of one or more rules included in the first rule(s) 146 would trigger or generate one or more alerts indicating that an individual customer or a group of customers corresponding to the first segment data 140 might be involved in the terrorist activity. The second rule(s) 147 can include rules directed to human trafficking. The violation of one or more rules included in the second rule(s) 147 would trigger or generate one or more alerts indicating that an individual customer or a group of customers corresponding to the first segment data 140 might be involved in the human trafficking.

However, the described above is not intended to be limiting. The first rule(s) 146 can include rules directed to the human trafficking or any other suspicious activity. Likewise, the second rule(s) 147 can include rules directed to the terrorist financing or any other suspicious activity. That is, as described above, each rule set of the rule sets 144 can be directed to a certain suspicious activity and can include one or more rules for alerting occurrence of that suspicious activity in the segment data being monitored.

The scenarios 145 may include one or more scenarios. For example, the scenarios 145 may include a first scenario 150 to an Nth scenario 152. Each scenario can include a combination of rules and/or conditions. For example, the alert for the first scenario 150 can be indicative of an individual customer or a group of customers that correspond to the first segment data 140 violating the first scenario 150.

Accordingly, the data capture subsystem 143 can process a certain segment data corresponding to any one among the first segment data 140 to the Mth segment data 142 using at least one or all of the first rule(s) 146 to the Kth rule(s) 149 and/or using at least one of the first scenario 150 to the Nth scenario 152, to determine if any of the records causes an alert. For example, the data capture subsystem 143 can include a model that can, based on one or more generated alerts, make a determination whether the certain segment data includes one or more suspicious events. In some implementations, the data capture subsystem 143 can, using a model, make the determination whether the certain segment data includes one or more suspicious events consistent with a particular category of the suspicious event based on one alert or a predefined combination of alerts. As an example, a predefined combination of alerts for the terrorist financing may be alerts for one of the rules included in the first rule(s) 146 and an alert for the first scenario 150.

The suspicious events for the same customer of the segment may include an associated customer identifier (ID). For example, the suspicious events for the same customer ID may be regarded as one case. In some embodiments, the suspicious events for the customers of the same segment may include an associated customer group identifier (ID), and the suspicious events for the same customer group ID may be regarded as one case.

As a result of the processing on the first segment data 140, the data capture subsystem 143 can provide an output including event data corresponding to the one or more suspicious events, e.g., cases that are generated based on processing the first segment data 140 and indicative of the focal entity included in the segment being involved in a category of the suspicious activity.

In some embodiments, the data capture subsystem 143 can provide information regarding the specific rules and/or scenarios that caused generation of the case.

The event monitoring subsystem 104 receives, from the data capture subsystem 143, the event data corresponding to the suspicious events and performs certain processing to output a probability of the suspicious event belonging to a certain suspicious activity category or class. The suspicious activity category may include human trafficking, animal trafficking, drug trafficking, terrorist financing, elder abuse, money laundering, etc.

In embodiments, the event monitoring subsystem 104 includes a plurality of ML models 130 including a first ML model 132 to an Lth ML model 134. For example, each of the plurality of ML models 130 is a probabilistic graph model such as a Bayesian network (BN) that includes a plurality of nodes. Each mode is assigned a probabilistic value based on the prior knowledge of the risk associated with a known suspicious activity. As used herein, the “prior knowledge of the risk” may refer to the prior knowledge of the risk associated with the segment or a plurality of segments of the same entity.

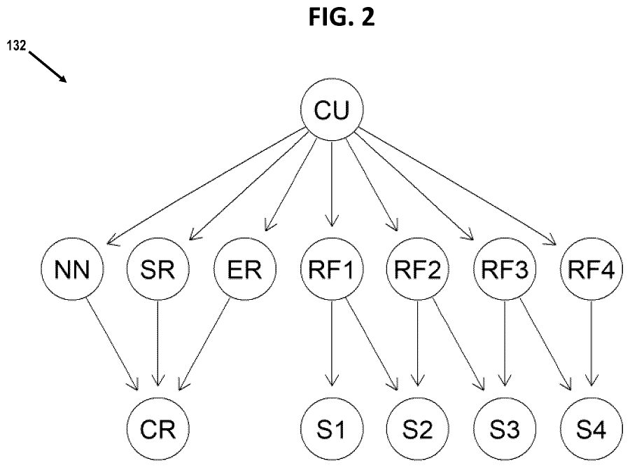

The BN and the assignment of values to the nodes are described in detail below with reference to FIG. 2.

In some implementations, each of the plurality of ML models 130 (e.g., a corresponding BN) can be configured to perform a particular task and output a probability of a focal entity included in a segment being involved in a certain suspicious activity category. For example, the first ML model 132 can be configured to detect a probability of the focal entity of a segment being involved in human trafficking, a second ML model 133 can be configured to detect a probability of the focal entity of a segment being involved in terrorist financing, etc.

However, the described above is not intended to be limiting. The second ML model 133 can be configured to detect a probability of the focal entity of a segment being involved in human trafficking or any other suspicious activity. Likewise, the first ML model 132 can be configured to detect a probability of the focal entity of a segment being involved in human trafficking or any other suspicious activity. That is, each ML model of the plurality of ML models 130 can be configured for processing events directed to a certain suspicious activity different from others.

Further, at least one of the plurality of ML models 130 can be implemented as a plurality of BNs configured to detect a probability of the focal entity of a segment being involved in a plurality of suspicious activity categories.

### A. Constructing Bayesian Network

FIG. 2 shows an example of a BN that can have a tree architecture. As described above, each of the plurality of ML models 130 is configured for processing the suspicious event to output a probability of a particular suspicious event, e.g., a probability of the focal entity within a segment being involved in terrorist financing, human trafficking, etc. For simplicity of description, the focal entity can be referred to below as a “customer.”

In an example below, the description is provided for the first ML model 132 configured to detect human trafficking. However, it is to be understood that the disclosed techniques are applicable to any one of the plurality of ML models 130, to be configured to detect a corresponding suspicious activity.

In an example of FIG. 2, the shown BN may correspond to the first ML model 132 and may be configured to detect human trafficking based on the segment data corresponding to the segment. However, this is not intended to be limiting and the BN for the first ML model 132 can be configured for a task different from human trafficking.

In an embodiment, the first ML model 132 can be constructed to align with rules, scenarios, etc., of the segment data monitoring subsystem 102. However, this is not intended to be limiting. In certain implementations, one or more of the plurality of ML models 130 are constructed first, and then rules, scenarios, etc., of the segment data monitoring subsystem 102 are set up to align with the plurality of ML models 130.

As shown in an example of FIG. 2, the first ML model 132 (e.g., BN) can be constructed to detect human trafficking with the following nodes based at least on the user's knowledge of the segment:
1) CU—Segment
2) NN—Negative News
3) SR—Sanctions Risk
4) ER—External Entity Risk
5) CR—Customer Risk
6) RF1—Red Flag 1—Terrorist Financing (TF) Red Flag
7) RF2—Red Flag 2—TF Red Flag
8) RF3—Red Flag 3—Human Trafficking (HT) Red Flag
9) RF4—Red Flag 4—HT Red Flag
10) S1—Scenario 1
11) S2—Scenario 2
12) S3—Scenario 3
13) S4—Human Trafficking Typology Scenario

For example, a top level node CU may identify a segment, e.g., a group of customers having at least one similar characteristic as described above.

The nodes at the next level (i.e., children of CU) are the NN, SR, and ER (negative news, sanctions risk, and external entity risk) and red flags 1 to 4.

For example, the red flags 1 to 4 may correspond to one or more rules that are set up for the segment data monitoring subsystem 102, e.g., a human trafficker is anticipated to trigger one or more of the red flags 1 to 4 that could correspond to at least some of the rule sets 144.

The nodes at the lowest level are output nodes.

The node CR (customer risk) is a child of the nodes NN, SR, and ER (negative news, sanctions risk, and external entity risk).

The node S1 (scenario 1) is the child of the node RF1 representing a first TF red flag. If the RF1 is triggered, S1 is triggered with some probability as defined by the conditional probability table tied to the node S1.

The node S2 (scenario 2) is the child of the node RF1 and the node RF2 representing a second TF red flag. If the RF1 and RF2 are triggered, S2 is triggered with some probability as defined by the conditional probability table tied to the node S2.

The node S3 (scenario 3) is the child of the node RF2 and the node RF3 representing a first HT red flag. If the RF2 and RF3 are triggered, S3 is triggered with some probability as defined by the conditional probability table tied to the node S3.

The node S4 (HT scenario) is the child of the node RF3 and the node RF4 representing a second HT red flag. If the RF3 and RF4 are triggered, S4 is triggered with some probability as defined by the conditional probability table tied to the node S3.

For example, all or some of the scenarios 1 to 4 may correspond to the scenarios that are set up for the segment data monitoring subsystem 102, e.g., a human trafficker may trigger alerts for scenarios 1 to 4 that could correspond to at least some of the scenarios 145 of the segment data monitoring subsystem 102.

FIG. 2 represents a structure showing that a CU (law abiding citizen or a human trafficker) is likely to transact in ways consistent with a red flag. When this happens, there is some probability of the scenario aligned to this red flag to trigger an alert, e.g., HT scenario.

However, the described-above is not intended to be limiting. In some implementations, the first ML model 132 can have different nodes, a different number of nodes, different architecture, etc.

With continuing reference to FIG. 2 and reference again to FIG. 1, each of the plurality of ML models 130 is configured for the particular task as a corresponding BN having a plurality of nodes arranged in a tree architecture that depends on which suspicious event the ML model is designed to detect (e.g., depends on the task of the ML model). As described in detail below, each of the nodes of each of the plurality of ML models 130 is initially associated with one or more values based on prior knowledge depending on the task of the model, e.g., as default values, and then updated using the parameter updating subsystem 106.

### B. Assigning Values to BN

After the nodes and their architecture are defined for the BN, as exemplarily described above and shown in FIG. 2, the conditional probability tables for each node are determined. For example, based on the expert knowledge, the values for the nodes of the BN may be assigned depending on which suspicious event is to be detected. In embodiments, each node may be associated with a parameter associated with a set of values. For example, the parameter may be associated with sub-parameters, where each sub-parameter is associated with one or more values.

In a non-limiting example below, the values of the conditional probability tables may be assigned for the BN (e.g., the first ML model 132) to be configured for human trafficking. Initially, the values can be assigned as default values, e.g., based on the expert or prior knowledge, as mentioned above.

### 1. Node CU-Segment

In an example, it is assumed that the constitution of the customers included in the segment is likely to belong to one of two categories: a law abiding citizen (“citizen”) or a human trafficker. This can be specified along with the prior expectation of probabilities as shown below.

CU.lv <- c(“citizen”,“human_trafficker”)
CU.prob <- array(c(0.999,0.001),dim=2, dimnames = list(CU.lv))
CU.prob

| ## | citizen human_trafficker | |
|---|---|---|
| ## | 0.999 | 0.001 |

As shown, based on the prior knowledge, the probability is set at 0.999 that a customer of a segment corresponds to a law abiding citizen and at 0.001 that a customer of a segment corresponds to a human trafficker.

Here, the CU is a parameter having two sub-parameters {citizen; human trafficker}. Each sub-parameter is associated with a value (e.g., probability) {citizen: 0.999; human trafficker: 0.001}. Herein, values of the sub-parameters are referred to as the set of values of the node CU or the set of values associated with the parameter CU.

### 2. Node NN-Negative News

In an example, it is assumed that the negative news is binary. There is either presence of negative news (Y) or absence of negative news (N). The presence of negative news depends on which category a customer belongs to.

NN.lv <- c(“y”,“n”)
NN.prob <- array(c(0.005,0.995,0.85,0.15), dim = c(2,2), dimnames =
list( NN = NN.lv,CU = CU.lv))
NN.prob

| ## | CU | | |
|---|---|---|---|
| ## | NN | citizen human_trafficker | |
| ## | y | 0.005 | 0.85 |
| ## | n | 0.995 | 0.15 |

As shown, based on prior knowledge, a law abiding citizen may have the probability of 0.005 of having the negative news while a human trafficker may have a probability of 0.85 of having a negative news report. Further, this implies that a law abiding citizen may have the probability of 0.995 of not having the negative news, while a human trafficker may have a probability of 0.15 of not having a negative news report. That is, it is much more likely that a human trafficker would have negative news as compared to a law abiding citizen.

### 3. Sanctions Risk

In an example, it is assumed that the sanctions risk is binary. If a customer of the segment is present on the sanctions list, risk is present (Y). Otherwise, the risk is absent (N).

SR.lv <- c(“y”,“n”)
SR.prob <- array(c(0.01,0.99,0.2,0.8), dim = c(2,2), dimnames = list(
SR = SR.lv,CU = CU.lv))
SR.prob

| ## | CU | | |
|---|---|---|---|
| ## SR | | citizen human_trafficker | |
| ## | y | 0.01 | 0.2 |
| ## | n | 0.99 | 0.8 |

As shown, based on prior knowledge, the probability of being present on the sanctions list is set at 0.01 for a law abiding citizen and at 0.2 for a human trafficker. The probability of not being present on the sanctions list is set at 0.99 for a law abiding citizen and at 0.8 for a human trafficker. That is, it is not a high probability that a human trafficker would be on a sanctions list.

### 4. External Entity Risk

External entity risk is the risk resulting from the counter parties to the customer interactions. In an example, the external entity risk can be high or low.

ER.lv <- c(“high”,“low”)
ER.prob <- array(c(0.005,0.995,0.5,0.5), dim = c(2,2), dimnames = list(
ER = ER.lv,CU = CU.lv))
ER.prob

| ## | CU | | |
|---|---|---|---|
| ## ER | | citizen human_trafficker | |
| ## | high | 0.005 | 0.5 |
| ## | low | 0.995 | 0.5 |

As shown, based on prior knowledge, the probability of presence of the external entity risk is set at 0.005 for a law abiding citizen and at 0.5 for a human trafficker. The probability of absence of the external entity risk is set at 0.995 for a law abiding citizen and at 0.5 for a human trafficker. That is, it is a 50/50 chance that a counter party to a human trafficker would present a risk.

### 5. Customer Risk

The risks described above (i.e., negative news, sanctions, and external entity) impact customer risk. The customer risk can be mapped to three customer risk levels-high, medium and low as follows.

| expand.grid(NN= NN.lv, SR = SR.lv, ER = ER.lv) | | | |
|---|---|---|---|
| ## | NN | SR | ER |
| ## 1 | y | y | high |
| ## 2 | n | y | high |
| ## 3 | y | n | high |
| ## 4 | n | n | high |
| ## 5 | y | y | low |
| ## 6 | n | y | low |
| ## 7 | y | n | low |
| ## 8 | n | n | low |

```
CR.lv <- c(“L”,“M”,“H”)
CR.prob <- array(c(0.01,0.04,0.95,0.05,0.1,0.85,0.05,0.05,0.9,0.4,0.4,0.2,0.3,0.3,0.4,
    0.4,0.4,0.2,0.3,0.4,0.3,0.95,0.04,0.01), dim = c(3,2,2,2),
  dimnames = list(CR = CR.lv,NN = NN.lv ,SR = SR.lv, ER = ER.lv))
CR.prob
```

| ## , , SR = y, ER = high | | | |
|---|---|---|---|
| ## | | | |
| ## | | NN | |
| ## | CR | y | n |
| ## | L | 0.01 | 0.05 |
| ## | M | 0.04 | 0.10 |
| ## | H | 0.95 | 0.85 |
| ## | | | |
| ## , , SR = n, ER = high | | | |
| ## | | | |
| ## | | NN | |
| ## | CR | y | n |
| ## | L | 0.05 | 0.4 |
| ## | M | 0.05 | 0.4 |
| ## | H | 0.90 | 0.2 |
| ## | | | |
| ## , , SR = y, ER = low | | | |
| ## | | | |
| ## | | NN | |
| ## | CR | y | n |
| ## | L | 0.3 | 0.4 |
| ## | M | 0.3 | 0.4 |
| ## | H | 0.4 | 0.2 |
| ## | | | |
| ## , , SR = n, ER = low | | | |
| ## | | | |
| ## | | NN | |
| ## | CR | y | n |
| ## | L | 0.3 | 0.95 |
| ## | M | 0.4 | 0.04 |
| ## | H | 0.3 | 0.01 |

### 6. Red Flags 1 to 4

Although these red flags could be triggered by a human trafficker, there is some chance that a regular citizen can trigger these red flags. The specific probabilities here depend on the quality and specificity of the red flag.

The table below shows probabilities for a red flag 1 (RF1) being triggered and not triggered by a law abiding citizen and a human trafficker.

RF1.lv <- c(“y”,“n”)
RF1.prob <- array(c(0.05,0.95,0.2,0.8), dim = c(2,2), dimnames = list( RF1 = RF1.lv,CU =
CU.lv))
RF1.prob

| ## | | CU | |
|---|---|---|---|
| ## | RF1 | citizen | human_trafficker |
| ## | y | 0.05 | 0.2 |
| ## | n | 0.95 | 0.8 |

As shown, based on prior knowledge, for RF1, the probability for a law abiding citizen triggering this red flag is set at 0.05 and for a human trafficker at 0.2. This implies the probability of not triggering this red flag is 0.95 for a law abiding citizen and 0.8 for a human trafficker. Presumably, RF1 is not a very specific flag, and, as shown, it is assumed that a regular citizen can trigger this flag.

The table below shows probabilities for a red flag 2 (RF2) being triggered and not triggered by a law abiding citizen and a human trafficker.

RF2.lv <- c(“y”,“n”)
RF2.prob <- array(c(0.025,0.975,0.3,0.7), dim = c(2,2), dimnames = list( RF2 = RF2.lv,CU =
CU.lv))
RF2.prob

| ## | | CU | |
|---|---|---|---|
| ## | RF2 | citizen | human_trafficker |
| ## | y | 0.025 | 0.3 |
| ## | n | 0.975 | 0.7 |

As shown, based on prior knowledge, for RF2, the probability of being triggered by a law abiding citizen is set at 0.025 and at 0.3 for a human trafficker. This implies the probability of not being triggered by a law abiding citizen is 0.975 and 0.7 for a human trafficker. Similarly, to RF1, this flag is not very specific and it is assumed that a regular citizen can trigger this flag.

The table below shows probabilities for a red flag 3 (RF3) being triggered and not triggered by a law abiding citizen and a human trafficker.

RF3.lv <- c(“y”,“n”)
RF3.prob <- array(c(0.01,0.99,0.9,0.1), dim = c(2,2), dimnames = list( RF3 = RF3.lv,CU =
CU.lv))
RF3.prob

| ## | | CU | |
|---|---|---|---|
| ## | RF3 | citizen | human_trafficker |
| ## | y | 0.01 | 0.9 |
| ## | n | 0.99 | 0.1 |

As shown, based on prior knowledge, for RF3, the probability of triggering a specific red flag RF3 is set at 0.01 for a law abiding citizen and at 0.9 for a human trafficker. This implies the probability of a red flag RF3 not triggered is 0.99 for a law abiding citizen and 0.1 for a human trafficker. In comparison to red flags RF1 and RF2, this red flag is assumed to be specific and there is 90% probability that a human trafficker would trigger this flag (as compared to 1% probability set for a law abiding citizen).

The table below shows probabilities for a red flag 4 (RF4) being triggered and not triggered by a law abiding citizen and a human trafficker.

RF4.lv <- c(“y”,“n”)
RF4.prob <- array(c(0.4,0.6,0.9,0.1), dim = c(2,2), dimnames = list( RF4 = RF4.lv,CU =
CU.lv))
RF4.prob

| ## | | CU | |
|---|---|---|---|
| ## | RF4 | citizen | human_trafficker |
| ## | y | 0.4 | 0.9 |
| ## | n | 0.6 | 0.1 |

As shown, based on prior knowledge, for RF4, the probability of being triggered is set at 0.4 for a law abiding citizen and at 0.9 for a human trafficker. This implies the probability of not being triggered is 0.6 for a law abiding citizen and 0.1 for a human trafficker. This red flag is assumed to be less specific than RF3. While there is 90% probability that a human trafficker would trigger this flag, there is also a probability of 40% set for a law abiding citizen triggering this flag.

### 7. Scenario 1

In an example, it is assumed that Scenario 1 is selected to monitor for RF1. Given the scenario has not been perfectly designed, it will trigger false alarms sometimes even in the absence of these red flag.

S1.lv <- c(“y”,“n”)
S1.prob <- array(c(0.4,0.6,0.01,0.99), dim = c(2,2), dimnames = list( S1 = S1.lv,RF1 =
RF1.lv))
S1.prob

| ## | | RF1 | |
|---|---|---|---|
| ## | S1 | y | n |
| ## | y | 0.4 | 0.01 |
| ## | n | 0.6 | 0.99 |

As shown, based on prior knowledge, when RF1 is triggered, the probability of S1 being triggered is set at 0.4 and not being triggered is set at 0.6. When RF1 is not triggered, the probability of S1 being triggered is set at 0.01 and not being triggered is set at 0.99. Thus, even when RF1 is not triggered, there is a slight chance that the scenario S1 will be triggered (e.g., falsely triggered).

### 8. Scenario 2

In an example, it is assumed that Scenario 2 is selected to monitor for red flags 1 and 2 (RF1 and RF2). Given the scenario has not been perfectly designed, it will trigger false alarms sometimes even in the absence of these red flags.

S2.lv <- c(“y”,“n”)
S2.prob <- array(c(0.95,0.05,0.6,0.4,0.6,0.4,0.1,0.9), dim = c(2,2,2),
dimnames = list(S2 = S2.lv,RF1 = RF1.lv ,RF2 = RF2.lv))
S2.prob

| ## , , RF2 = y | | | |
|---|---|---|---|
| ## | | | |
| ## | | RF1 | |
| ## | S2 | y | n |
| ## | y | 0.95 | 0.6 |
| ## | n | 0.05 | 0.4 |
| ## | | | |
| ## , , RF2 = n | | | |
| ## | | | |
| ## | | RF1 | |
| ## | S2 | y | n |
| ## | y | 0.6 | 0.1 |
| ## | n | 0.4 | 0.9 |

As shown, based on prior knowledge, when RF2 and RF1 are triggered, the probability of S2 being triggered is set at 0.95 and not being triggered is set at 0.05. When RF2 is triggered but RF1 is not triggered, the probability of S2 being triggered is set at 0.6 and not being triggered is set at 0.4.

When RF2 and RF1 are not triggered, the probability of S2 being triggered is set at 0.1 and not being triggered is set at 0.9. When RF1 is triggered but RF2 is not triggered, the probability of S2 being triggered is set at 0.6 and not being triggered is set at 0.4.

### 9. Scenario 3

In an example, it is assumed that Scenario 3 is selected to monitor for red flags 2 and 3 (RF2 and RF3). Given the scenario has not been perfectly designed, it will trigger false alarms sometimes even in the absence of these red flags.

S3.lv <- c(“y”,“n”)
S3.prob <- array(c(0.95,0.05,0.5,0.5,0.5,0.5,0.3,0.7), dim = c(2,2,2),
dimnames = list(S3 = S3.lv,RF2 = RF2.lv ,RF3 = RF3.lv))
S3.prob

| ## | , , RF3 = y | | |
|---|---|---|---|
| ## | | | |
| ## | RF2 | | |
| ## | S3 | y | n |
| ## | y 0.95 0.5 | | |
| ## | n 0.05 0.5 | | |
| ## | | | |
| ## | , , RF3 = n | | |
| ## | | | |
| ## | RF2 | | |
| ## | S3 | y | n |

| | |
|---|---|
| ## | y 0.5 0.3 |
| ## | n 0.5 0.7 |

As shown, based on prior knowledge, when RF2 and RF3 are triggered, the probability of S3 being triggered is set at 0.95 and not being triggered is set at 0.05. When RF3 is triggered but RF2 is not triggered, the probability of S3 being triggered is set at 0.5 and not being triggered is set at 0.5.

When RF2 and RF3 are not triggered, the probability of S3 being triggered is set at 0.3 and not being triggered is set at 0.7. When RF2 is triggered but RF3 is not triggered, the probability of S3 being triggered is set at 0.5 and not being triggered is set at 0.5.

### 10. Scenario 4—Human Trafficking

In an example, it is assumed that Scenario 4 is a targeted scenario focused on human trafficking red flags (RF3 and RF4), for monitoring human trafficking. Given this has been tailored for only the human trafficking, it will have fewer false alarms.

S4.lv <− c(“y”,“n”)
S4.prob <− array(c(0.99,0.01,0.1,0.9,0.1,0.9,0.01,0.99), dim = c(2,2,2),
dimnames = list(S4 = S4.lv,RF3 = RF3.lv ,RF4 = RF4.lv))
S4.prob

| ## | , , RF4 = y | | |
|---|---|---|---|
| ## | | | |
| ## | RF3 | | |
| ## | S4 | y | n |
| ## | y 0.99 0.1 | | |
| ## | n 0.01 0.9 | | |
| ## | | | |
| ## | , , RF4 = n | | |
| ## | | | |
| ## | RF3 | | |
| ## | S4 | y | n |

| | |
|---|---|
| ## | y 0.1 0.01 |
| ## | n 0.9 0.99 |

As shown, based on prior knowledge, when RF4 and RF3 are triggered, the probability of S4 being triggered is set at 0.99 and not being triggered is set at 0.01. When RF4 is triggered but RF3 is not triggered, the probability of S4 being triggered is set at 0.1 and not being triggered is set at 0.9.

When RF2 and RF3 are not triggered, the probability of S4 being triggered is set at 0.01 and not being triggered is set at 0.99. When RF3 is triggered but RF4 is not triggered, the probability of S4 being triggered is set at 0.1 and not being triggered is set at 0.9.

C. Configuring BN based on CPT

The Bayesian network can be configured based on the conditional probability tables that are exemplarily shown above, as follows:

```
tms.cpt <− list(CU = CU.prob, NN = NN.prob, SR = SR.prob, ER = ER.prob, CR = CR.prob,
  RF1 = RF1.prob , RF2 = RF2.prob, RF3 = RF3.prob , RF4 = RF4.prob,
  S1 = S1.prob , S2 = S2.prob, S3 = S3.prob, S4 = S4.prob)
tms.bn <− custom.fit(tms.dag,tms.cpt)
```

The conditional probability tables may be stored in corresponding nodes of the first ML model 132.

Referring again to FIG. 1, as mentioned above, the event monitoring subsystem 104 receives the suspicious events from the data capture subsystem 143 and uses one of the plurality of ML models 130 to perform certain processing and output a probability of the suspicious event belonging to a certain suspicious activity category. For example, the event monitoring subsystem 104 receives a user input through the UI subsystem 122 for selecting the first ML model 132 configured for processing the suspicious events associated with the human trafficking.

The first ML model 132 receives, as an input, the event data corresponding to one or more cases, where each of the cases may respectively include a suspicious event for a corresponding customer of the segment. For example, the first ML model 132 processes the case and outputs the probability of the customer being involved in the human trafficking. The first ML model 132 also outputs the description of the red flags that were triggered and the associated probabilities. This is described below in the section entitled “Example of Output Result.”

However, the described above is not intended to be limiting. In some implementations, at least one of the cases, the event data of which is passed on to the ML model, may include suspicious events for a group of the customers of the segment, where the suspicious events may belong to the same category of suspicious events (e.g., terrorist financing) or different categories of suspicious events (e.g., terrorist financing and human trafficking).

The postprocessing subsystem 108 may receive an output result from the first ML model 132 and perform some processing to format the result in a human-readable format. Then, the result may be provided to the output device 126 for display. However, in some embodiments, the postprocessing subsystem 108 may be omitted. For example, the output result may be directly sent to the output device 126 or sent to an external device for postprocessing and/or display.

The analyst may analyze the output result and provide a user input through the input device 124 to update one or more values of one or more parameters of the first ML model 132. The parameter updating subsystem 106 may receive one or more signals corresponding to the user input. The parameter updating subsystem 106 may communicate with the event monitoring subsystem 104 to update the first ML model 132. This is described below in the section entitled “Updating the Model.”

Also, the analyst may provide update for the values of the rules parameters 112 and/or the values of the scenarios parameters 114.

### III. EXAMPLES OF INFERENCE

In an example, the customer in question is high risk (i.e., CR=high), and triggers an alert for scenario 1, but not for scenarios 2 to 4. The probability of the customer being a human trafficker is given by

```
  cpquery(tms.bn, event = (CU == “human_trafficker”), evidence = ((CR == “H”) & (S1
== “y”)), n = 10\hat{ }6)
  ## [1] 0.1207627
```

The probability of the customer being a law-abiding citizen is given by

```
  cpquery(tms.bn, event = (CU == “citizen”), evidence = ((CR == “H”) & (S1 == “y”)), n
= 10\hat{ }6)
  ## [1] 0.8712274
```

In an example, the customer in question is low risk (i.e., CR=low) and triggers an alert for scenario 1, but not for scenarios 2 to 4. The probability of the customer being a human trafficker is given by

```
  cpquery(tms.bn, event = (CU == “human_trafficker”), evidence = ((CR == “L”) & (S1
== “y”)), n = 10\hat{ }6)
  ## [1] 0.000729049
```

The probability of the customer being a law-abiding citizen is given by

```
  cpquery(tms.bn, event = (CU == “citizen”), evidence = ((CR == “L”) & (S1 == “y”)), n
= 10\hat{ }6)
  ## [1] 0.9992334
```

In an example, the customer in question is low risk and triggers an alert for scenario 4, but not for scenarios 1, 2, or 3. The probability of the customer being a human trafficker is given by

```
  cpquery(tms.bn, event = (CU == “human_trafficker”), evidence = ((CR == “L”) & (S4
== “y”)), n = 10\hat{ }6)
  ## [1] 0.004348568
```

The probability of the customer being a law-abiding citizen is given by

```
  cpquery(tms.bn, event = (CU == “citizen”), evidence = ((CR == “L”) & (S4 == “y”)), n
= 10\hat{ }6)
  ## [1] 0.9961383
```

In an example, the customer in question is high risk and triggers an alert for scenario 4, but not for scenarios 1, 2, or 3. The probability of the customer being a human trafficker is given by

```
  cpquery(tms.bn, event = (CU == “human_trafficker”), evidence = ((CR == “H”) & (S4
== “y”)), n = 10\hat{ }6)
  ## [1] 0.3746814
```

The probability of the customer being a law-abiding citizen is given by

```
  cpquery(tms.bn, event = (CU == “citizen”), evidence = ((CR == “H”) & (S4 == “y”)), n
= 10\hat{ }6)
  ## [1] 0.6163793
```

As shown, these predictions represent a testable consequence of the theory.

### IV. EXAMPLE OF OUTPUT RESULT

In embodiments, a description is provided with a diagnosis of whether the focal entity (customer, account, external entity) in question is a financial criminal and what red flag or flags were triggered. In an example, it is assumed that the customer is a medium risk that triggered an alert for Scenario 4 but no alerts for the other scenarios.

p_HT <− cpquery(tms.bn, event = (CU == “human_trafficker”), evidence = ((CR == “M”) &
(S1 ==“n”) & (S2 ==“n”) & (S3 ==“n”) & (S4 == “y”)), n = 10\hat{ }6)
p_Citizen <− cpquery(tms.bn, event = (CU == “citizen”), evidence = ((CR == “M”) & (S1
==“n”) & (S2 ==“n”) & (S3 ==“n”) & (S4 == “y”)), n = 10\hat{ }6)
c(p_HT,p_Citizen)
## [1] 0.02768166 0.95833333

p_RF1 <− cpquery(tms.bn, event = (RF1 == “y”), evidence = ((CR == “M”) & (S1 ==“n”) &
(S2 ==“n”) & (S3 ==“n”) & (S4 == “y”)), n = 10\hat{ }6)
p_RF2 <− cpquery(tms.bn, event = (RF2 == “y”), evidence = ((CR == “M”) & (S1 ==“n”) &
(S2 ==“n”) & (S3 ==“n”) & (S4 == “y”)), n = 10\hat{ }6)
p_RF3 <− cpquery(tms.bn, event = (RF3 == “y”), evidence = ((CR == “M”) & (S1 ==“n”) &
(S2 ==“n”) & (S3 ==“n”) & (S4 == “y”)),n = 10\hat{ }6)
p_RF4 <− cpquery(tms.bn, event = (RF4 == “y”), evidence = ((CR == “M”) & (S1 ==“n”) &
(S2 ==“n”) & (S3 ==“n”) & (S4 == “y”)),n = 10\hat{ }6)
c(p_RF1,p_RF2,p_RF3,p_RF4)
## [1] 0.014471780 0.007407407 0.101098901 0.875608061

As shown in Table 1 below, the human-readable result can provide that there is a 2.77% chance that the customer is a human-trafficker and that this customer violated RF1 with a probability of 0.01, RF2 with a probability of 0.01, RF3 with a probability of 0.1, and RF4 with a probability of 0.88.

TABLE 1
cat(paste0(“This customer has a ”, round(p_HT*100,2),“% chance of being a Human
Trafficker”,“\n”))
## This customer has a 2.77% chance of being a Human Trafficker
cat(paste0(“This customer has violated RF1 with a probability of ”,round(p_RF1,2),“\n”))
## This customer has violated RF1 with a probability of 0.01
cat(paste0(“This customer has violated RF2 with a probability of ”,round(p_RF2,2),“\n”))
## This customer has violated RF2 with a probability of 0.01
cat(paste0(“This customer has violated RF3 with a probability of ”,round(p_RF3,2),“\n”))
## This customer has violated RF3 with a probability of 0.1
cat(paste0(“This customer has violated RF4 with a probability of ”,round(p_RF4,2),“\n”))
## This customer has violated RF4 with a probability of 0.88

As can be deduced from Table 1, the customer has a 2.77% chance of being a human trafficker. The system also identifies RF4 as the most likely cause of identifying this customer as a human trafficker as there is a probability of 0.88 that this customer violated this red flag.

In embodiments, based on the output provided by the event monitoring subsystem 104, the postprocessing subsystem 108 can generate and provide to the output device 126, a detailed description of the activity that caused the case being generated, as for example, “the online interactions are not commensurate with the stated business type and/or unusual and unexpected in comparison with the volumes of similar businesses operating in the same locale.”

The analyst will review the case to determine whether the customer was actually a human trafficker and whether each of the red flags was violated. For example, the specification of the analyst may correspond to one of the rule sets 144 and state that the activity triggering RF4 includes conducting interactions that involve more wire transfers than a certain threshold, cash deposits exceeding a certain amount, a certain count, or a certain frequency, or person to person (P2P) payments from originators exceeding a certain count from different geographic locations either across the (1) US, or (2) Mexico and Central America, to one beneficiary located on or around the South West border, with no apparent business purpose.

The analyst may review the case to determine if the customer in fact conducted activities consistent with the descriptions of activities triggering RF4. However, this is not intended to be limiting. For example, a trained ML model can be provided with a prompt requesting to review the case built on the segment data and determine if the behavioral pattern consistent with RF4 is present. In some embodiments, the ML model can be a large language model (LLM) trained on large corpus.

The creation of cases as customers transact and the disposition of this cases represent a natural experiment where evidence is collected for or against the theory.

### V. UPDATING THE MODEL

The analyst can provide feedback for each of the red flags and/or scenarios as well as the diagnosis that the customer might be a human trafficker, as for example:
Whether the red flag was correctly triggered based on whether the customer demonstrated the behavior described for this red flag by corresponding set of rules.
Whether the customer was actually a human trafficker.

For example, the review of the above case by the analyst revealed the following facts:
S1, S2, and S3 did not trigger an alert.
S4 triggered an alert.
RF1 was not triggered as per analyst.
RF2 was not triggered as per analyst.
RF3 was triggered as per analyst.
RF4 was triggered as per analyst.
The case was indicative of human trafficking as per analyst.

As a result of the review, the conditional probability tables associated with each of the scenarios and red flags can be updated. Below, as a non-limiting example, the description of update is provided with respect to RF2, RF4, S3, and S4.

### 1. Updating RF2

In this example, RF2 was triggered per model's output, but not according to the analyst. Since the verification showed that RF2 was not actually triggered, this means that RF2 is not as indicative of human trafficking as previously thought. This means that, for RF2, the probability can be lowered, as shown below.

The prior probability of a human trafficker triggering RF2 is described above and is as follows:

| RF2.prob | | | |
|---|---|---|---|
| ## | CU | | |
| ## | RF2 citizen human_trafficker | | |
| ## | y | 0.025 | 0.3 |
| ## | n | 0.975 | 0.7 |

Assuming the prior probability of a human trafficker triggering RF2 was given by a Beta (3, 7) distribution, this can now be updated to a Beta (3, 8) distribution with a mean of 0.27. The conditional probability table for RF2 can be updated as follows:

| RF2.prob <− array(c(0.01,0.99,0.27,0.73), | | | |
|---|---|---|---|
| dim = c(2,2), dimnames = list( RF2 = RF2.lv,CU = | | | |
| CU.lv)) | | | |
| RF2.prob | | | |
| ## | CU | | |
| ## | RF2 citizen human_trafficker | | |
| ## | y | 0.01 | 0.27 |
| ## | n | 0.99 | 0.73 |

The values of the model can be updated, e.g., the new values can be stored in the node RF2.

### 2. Updating RF4

Since the verification showed that RF4 was triggered, this is the evidence that the human trafficker actually triggers this red flag. Since the verification showed that RF4 was actually triggered, this means that RF4 is important in detecting the human trafficking. This means that, for RF4, the probability can be increased, as shown below.

The prior probability of a human trafficker triggering RF4 is described above and is as follows:

| RF4.prob | | | |
|---|---|---|---|
| ## | CU | | |
| ## | RF4 citizen human_trafficker | | |
| ## | y | 0.4 | 0.9 |
| ## | n | 0.6 | 0.1 |

Assuming the prior probability of a human trafficker triggering RF4 was given by a Beta (9,1) distribution. This can now be updated to a Beta (10,1) distribution with a mean of 0.909. The conditional probability table for RF4 can be updated as follows:

| RF4.lv <− c(“y”,“n”) | | | |
|---|---|---|---|
| RF4.prob <− array(c(0.4,0.6,0.909,0.091), | | | |
| dim = c(2,2), dimnames = list( RF4 = RF4.lv,CU = | | | |
| CU.lv)) | | | |
| RF4.prob | | | |
| ## | CU | | |
| ## | RF4 citizen human_trafficker | | |
| ## | y | 0.4 | 0.909 |
| ## | n | 0.6 | 0.091 |

The values of the model can be updated, e.g., the new values can be stored in the node RF4.

### 3. Updating Scenario 3 (S3)

Scenario 3 never triggered an alert. Scenario 3 was true negative for RF2, but a false negative for RF3. This can be used to update the conditional probability table for S3. The conditional probability table for S3 is described above and is as follows:

| S3.prob | | |
|---|---|---|
| ## | , , RF3 = y | |
| ## | | |
| ## | RF2 | |
| ## | S3 | y n |
| ## | y 0.95 0.5 | |
| ## | n 0.05 0.5 | |
| ## | | |
| ## | , , RF3 = n | |
| ## | | |
| ## | RF2 | |
| ## | S3 | y n |

| | |
|---|---|
| ## | y 0.5 0.3 |
| ## | n 0.5 0.7 |

Assuming that for the case when a customer demonstrates activity consistent with RF3 but not with RF2, the prior probability of scenario S3 alert is given by Beta (5,5). Given that Scenario 3 did not trigger an alert in this case, the probabilities may be updated to Beta (5,6).

S3.lv <− c(“y”,“n”)
S3.prob <− array(c(0.95,0.05,0.46,0.54,0.5,0.5,0.27,0.73), dim = c(2,2,2),
dimnames = list(S3 = S3.lv,RF2 = RF2.lv ,RF3 = RF3.lv))
S3.prob

| ## | , , RF3 = y | |
|---|---|---|
| ## | | |
| ## | RF2 | |
| ## | S3 | y n |
| ## | y 0.95 0.46 | |
| ## | n 0.05 0.54 | |
| ## | | |
| ## | , , RF3 = n | |
| ## | | |
| ## | RF2 | |
| ## | S3 | y n |

| | |
|---|---|
| ## | y 0.5 0.27 |
| ## | n 0.5 0.73 |

The values of the model can be updated, e.g., the new values can be stored in the node S3.

### 4. Updating Scenario 4 (S4)

The fact that S4 was triggered correctly for RF3 and RF4 means there is more evidence that S4 can accurately detect these red flags. The conditional probability table for S3 is described above and is as follows:

| S4.prob | | | |
|---|---|---|---|
| ## | , , RF4 = y | | |
| ## | | | |
| ## | RF3 | | |
| ## | S4 | y | n |
| ## | y 0.99 0.1 | | |
| ## | n 0.01 0.9 | | |
| ## | | | |
| ## | , , RF4 = n | | |
| ## | | | |
| ## | RF3 | | |
| ## | S4 | y | n |

| | |
|---|---|
| ## | y 0.1 0.01 |
| ## | n 0.9 0.99 |

Assume that for the case when a customer of a segment demonstrates activity consistent with RF3 and RF4, the prior probability of scenario creating an alert is given by Beta (99,1). These probabilities can be updated to Beta (100,1). This makes difference only in the 4th decimal, so this can be left unchanged.

As described above, the values of the model can be continuously updated, e.g., the new values can be stored in the corresponding nodes and used in the next detection cycle on the batch of records for the segment.

The model learning from feedback represents updating belief in the theory based on the collected evidence. Over time this can lead to lowering or raising the belief in the significance of a red flag or the efficacy of a scenario.

By considering the prior probability of a customer being a financial criminal and the uncertainty associated with red flags and scenarios, a more realistic probability of the customer being a bad actor can be computed. By setting the threshold required for investigations to be a higher value, false positives can be significantly reduced.

As analysts review cases and provide feedback, the model can continuously learn and over time is guaranteed to converge to the true model, by being updated in a manner consistent with the scientific method.

If the user wants to monitor a new red flag or add a new rule, it is as simple as adding a new node to the Bayesian network.

Other model representations could be considered.

### VI. USAGE OF SUSPICIOUS ACTIVITY DETECTION SYSTEM

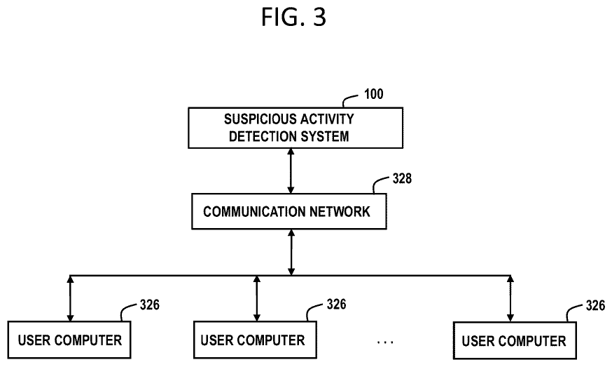

As shown in FIG. 3, the suspicious activity detection system 100 can be provided as a part of a distributed computing environment, where the suspicious activity detection system 100 is connected to one or more user computers 326 via a communication network 328. An example of a distributed computing environment is depicted in FIG. 8 and described in detail below.

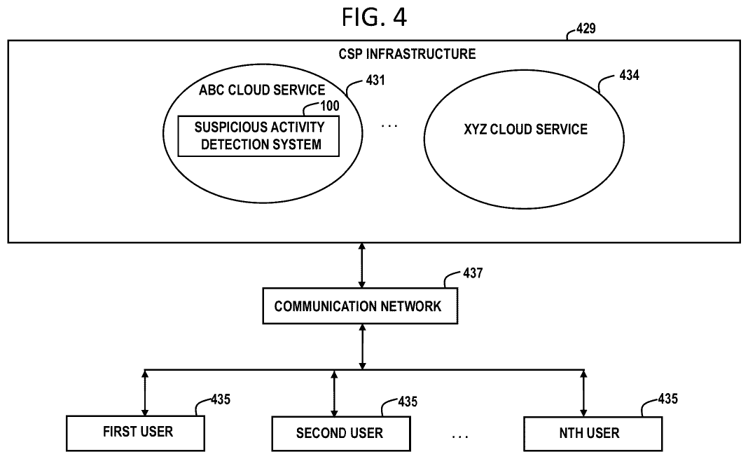

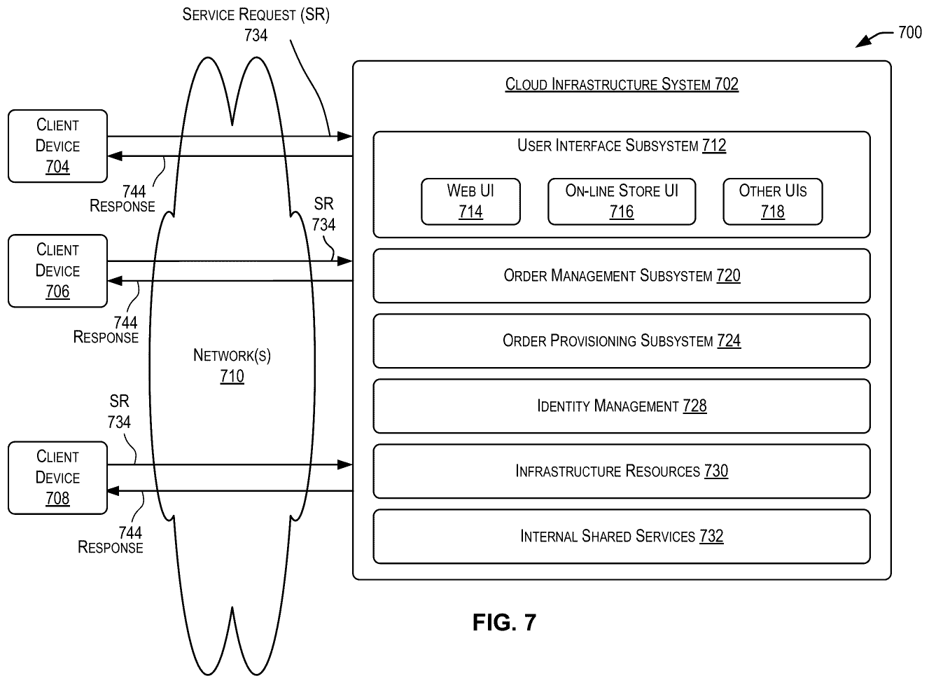

As shown in FIG. 4, the suspicious activity detection system 100 may be a part of a CSP infrastructure 429 provided by a CSP for providing one or more cloud services. For example, the one or more cloud services may include ABC cloud service 431 to XYZ cloud service 434 connected to computers of one or more users 435 via a communication network 437. For example, the suspicious activity detection system 100 may be a part of the ABC cloud service 431. An example of a CSP is depicted in FIG. 7 and described in detail below.

### VII. METHOD

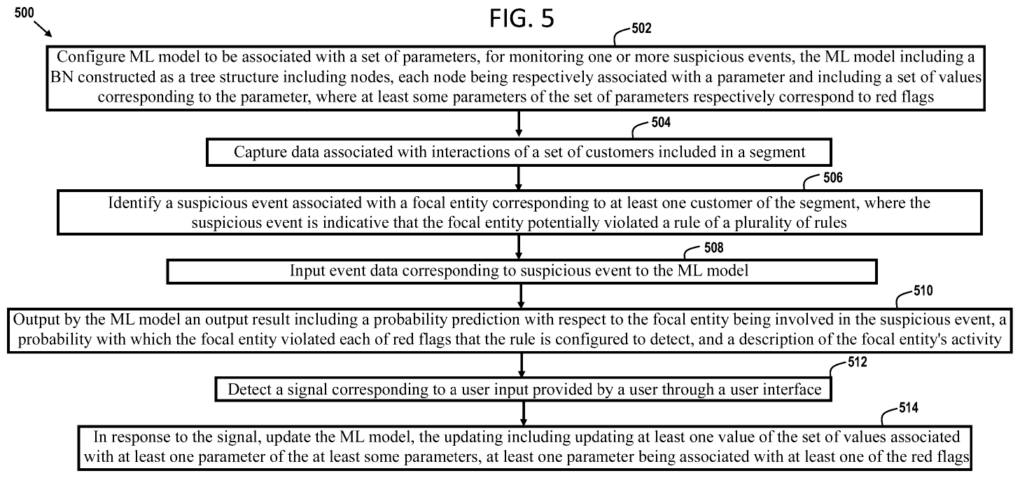

FIG. 5 is a simplified block diagram of a processing 500 performed by the suspicious activity detection system 100 in accordance with various embodiments. The processing 500 may be performed by all or some of the data capture subsystem 143, the event monitoring subsystem 104, the parameter updating subsystem 106, and the postprocessing subsystem 108.

The processing 500 depicted in FIG. 5 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing operations occurring in a particular sequence or order, this is not intended to be limiting. In certain alternative embodiments, the processing 500 may be performed in some different order or some operations may be performed at least partially in parallel.

Referring to FIG. 5, at operation 502, the suspicious activity detection system 100 may configure a machine learning (ML) model to be associated with a set of parameters, for monitoring events, the ML model including a Bayesian network (BN) constructed as a tree structure including nodes, each node being respectively associated with a parameter of the set of parameters and including a set of values corresponding to the parameter, where at least some parameters of the set of parameters correspond to red flags and/or scenarios.

In embodiments, the set of parameters include the first plurality of parameters respectively corresponding to data points of a plurality of external sources and the second plurality of parameters respectively corresponding to red flags and/or scenarios.

In embodiments, the ML model is a probabilistic graph model.

In embodiments, a plurality of ML models is configured, each of the plurality of ML models being configured to monitor a certain suspicious event among a plurality of suspicious events, where each ML model of the plurality of ML models is configured as a BN constructed as a tree structure of a certain architecture including nodes associated with a certain set of parameters particular to each ML model, to monitor the certain suspicious event among the plurality of suspicious events. Each node of each ML model stores a set of values associated with the certain set of parameters.

At operation 504, the data capture subsystem 143 may capture data associated with interactions of a set of customers included in a segment.

At operation 506, the data capture subsystem 143 may identify, based on the plurality of rules, one or more suspicious events associated with the focal entity (customer, a group of customers, account, or external entity), the one or more suspicious events indicative of the focal entity potentially violating a rule of the plurality of rules.

At operation 508, the data capture subsystem 143 may provide, as an input, event data corresponding to the one or more suspicious events to the ML model.

At operation 510, the ML model may output an output result including (1) a probability prediction with respect to the focal entity being involved in the suspicious event, (2) a probability with which the focal entity violated each of one or more red flags that the rule is configured to detect, and (3) a description of an activity that caused a violation of the one or more red flags.

In embodiments, the report may be displayed on a display of a user device, for a user to identify that an update of the ML model is to be performed.

At operation 512, the parameter updating subsystem 106 may detect a signal corresponding to a user input provided by a user through a user interface in response to the output result.

At operation 514, the parameter updating subsystem 106 may, in response to the signal, update the ML model, the updating including updating at least one value of the set of values associated with at least one parameter of the at least some parameters, at least one parameter being associated with at least red flag and/or at least one scenario.

In embodiments, the ML model is continually updated.

### VIII. ILLUSTRATIVE SYSTEMS

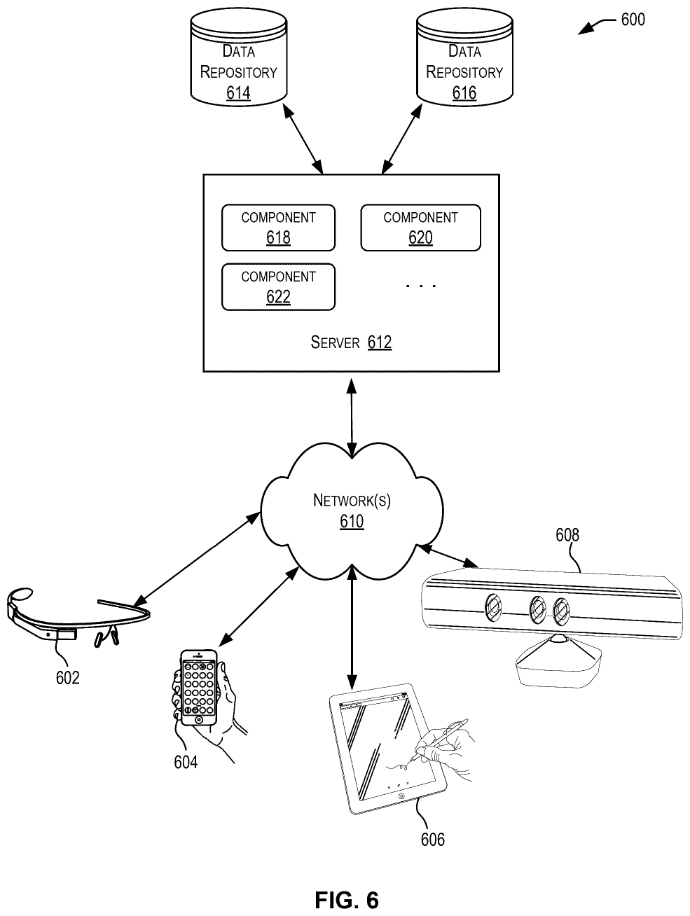

FIG. 6 depicts a simplified diagram of a distributed system 600. In the illustrated example, distributed system 600 includes one or more client computing devices 602, 604, 606, and 608, coupled to a server 612 via one or more communication networks 610. Clients computing devices 602, 604, 606, and 608 may be configured to execute one or more applications.

In various examples, server 612 may be adapted to run one or more services or software applications that enable one or more embodiments described in this disclosure. In certain examples, server 612 may also provide other services or software applications that may include non-virtual and virtual environments. In some examples, these services may be offered as web-based or cloud services, such as under a Software as a Service (Saas) model to the users of client computing devices 602, 604, 606, and/or 608. Users operating the client computing devices 602, 604, 606, and/or 608 may in turn utilize one or more client applications to interact with server 612 to utilize the services provided by these components.

In the configuration depicted in FIG. 6, server 612 may include one or more components 618, 620 and 622 that implement the functions performed by server 612. These components may include software components that may be executed by one or more processors, hardware components, or combinations thereof. It should be appreciated that various different system configurations are possible, which may be different from distributed system 600. The example shown in FIG. 6 is thus one example of a distributed system for implementing an example system and is not intended to be limiting.

Users may use the client computing devices 602, 604, 606, and/or 608 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 6 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Communication network(s) 610 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, communication network(s) 610 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 612 may be composed of one or more general purpose computers, specialized server computers (including, by way of example, personal computer (PC) servers, UNIX® servers, mid-range servers, mainframe computers, rack-mounted servers, etc.), server farms, server clusters, or any other appropriate arrangement and/or combination. Server 612 may include one or more virtual machines running virtual operating systems, or other computing architectures involving virtualization such as one or more flexible pools of logical storage devices that may be virtualized to maintain virtual storage devices for the server. In various examples, server 612 may be adapted to run one or more services or software applications that provide the functionality described in the foregoing disclosure.

The computing systems in server 612 may run one or more operating systems including any of those discussed above, as well as any commercially available server operating system. Server 612 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 612 may include one or more applications to analyze and consolidate data feeds and/or event updates received from users of client computing devices 602, 604, 606, and 608. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 612 may also include one or more applications to display the data feeds and/or real-time events via one or more display devices of client computing devices 602, 604, 606, and 608.

Distributed system 600 may also include one or more data repositories 614, 616. These data repositories may be used to store data and other information in certain examples. For example, one or more of the data repositories 614, 616 may be used to store information such as information related to chatbot performance or generated models for use by chatbots used by server 612 when performing various functions in accordance with various embodiments. Data repositories 614, 616 may reside in a variety of locations. For example, a data repository used by server 612 may be local to server 612 or may be remote from server 612 and in communication with server 612 via a network-based or dedicated connection. Data repositories 614, 616 may be of different types. In certain examples, a data repository used by server 612 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 614, 616 may also be used by applications to store application data. The data repositories used by applications may be of different types such as, for example, a key-value store repository, an object store repository, or a general storage repository supported by a file system.

In certain examples, the functionalities described in this disclosure may be offered as services via a cloud environment. FIG. 7 is a simplified block diagram of a cloud-based system environment in which various services may be offered as cloud services in accordance with certain examples. In the example depicted in FIG. 7, cloud infrastructure system 702 may provide one or more cloud services that may be requested by users using one or more client computing devices 704, 706, and 708. Cloud infrastructure system 702 may include one or more computers and/or servers that may include those described above for server 612. The computers in cloud infrastructure system 702 may be organized as general purpose computers, specialized server computers, server farms, server clusters, or any other appropriate arrangement and/or combination.

Network(s) 710 may facilitate communication and exchange of data between client computing devices 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The example depicted in FIG. 7 is only one example of a cloud infrastructure system and is not intended to be limiting. It should be appreciated that, in some other examples, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative examples.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the customer's own on-premises servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 702 may provide one or more cloud services using different models such as under a Software as a Service (SaaS) model, a Platform as a Service (PaaS) model, an Infrastructure as a Service (IaaS) model, and others, including hybrid service models. Cloud infrastructure system 702 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 702. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 702. Cloud infrastructure system 702 then performs processing to provide the services requested in the customer's subscription order. For example, a user may use utterances to request the cloud infrastructure system to take a certain action (e.g., an intent), as described above, and/or provide services for a chatbot system as described herein. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public customer, where the customer may be an individual or an enterprise. In certain other examples, under a private cloud model, cloud infrastructure system 702 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 702 and the services provided may be shared by several organizations in a related community. Various other models such as hybrids of the above mentioned models may also be used.

Client computing devices 704, 706, and 708 may be of different types (such as client computing devices 602, 604, 606, and 608 depicted in FIG. 6) and may be capable of operating one or more client applications. A user may use a client device to interact with cloud infrastructure system 702, such as to request a service provided by cloud infrastructure system 702. For example, a user may use a client device to request information or action from a chatbot as described in this disclosure.

In some examples, the processing performed by cloud infrastructure system 702 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 702 for generating and training one or more models for a chatbot system. The data used for this analysis may include structured data (e.g., data stored in a database or structured according to a structured model) and/or unstructured data (e.g., data blobs (binary large objects)).

As depicted in the example in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like. In certain examples, the storage virtual machines that are available for servicing storage requested from applications may be part of cloud infrastructure system 702. In other examples, the storage virtual machines may be part of different systems.

In certain examples, to facilitate efficient provisioning of these resources for supporting the various cloud services provided by cloud infrastructure system 702 for different customers, the resources may be bundled into sets of resources or resource modules (also referred to as “pods”). Each resource module or pod may include a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may include multiple subsystems. These subsystems may be implemented in software, or hardware, or combinations thereof. As depicted in FIG. 7, the subsystems may include a user interface subsystem 712 that enables users or customers of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a customer may, using a client device, request (service request 734) one or more services provided by cloud infrastructure system 702 using one or more of interfaces 714, 716, and 718. For example, a customer may access the online store, browse cloud services offered by cloud infrastructure system 702, and place a subscription order for one or more services offered by cloud infrastructure system 702 that the customer wishes to subscribe to. The service request may include information identifying the customer and one or more services that the customer desires to subscribe to. For example, a customer may place a subscription order for a service offered by cloud infrastructure system 702. As part of the order, the customer may provide information identifying a chatbot system for which the service is to be provided and optionally one or more credentials for the chatbot system.

In certain examples, such as the example depicted in FIG. 7, cloud infrastructure system 702 may include an order management subsystem (OMS) 720 that is configured to process the new order. As part of this processing, OMS 720 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 702 as part of the provisioning process. Cloud infrastructure system 702 may generate an application ID and select a storage virtual machine for an application from among storage virtual machines provided by cloud infrastructure system 702 itself or from storage virtual machines provided by other systems other than cloud infrastructure system 702.

Cloud infrastructure system 702 may send a response or notification 744 to the requesting customer to indicate when the requested service is now ready for use. In some instances, information (e.g., a link) may be sent to the customer that enables the customer to start using and availing the benefits of the requested services. In certain examples, for a customer requesting the service, the response may include a chatbot system ID generated by cloud infrastructure system 702 and information identifying a chatbot system selected by cloud infrastructure system 702 for the chatbot system corresponding to the chatbot system ID.

Cloud infrastructure system 702 may provide services to multiple customers. For each customer, cloud infrastructure system 702 is responsible for managing information related to one or more subscription orders received from the customer, maintaining customer data related to the orders, and providing the requested services to the customer. Cloud infrastructure system 702 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 702 may provide services to multiple customers in parallel. Cloud infrastructure system 702 may store information for these customers, including possibly proprietary information. In certain examples, cloud infrastructure system 702 includes an identity management subsystem (IMS) 728 that is configured to manage customer information and provide the separation of the managed information such that information related to one customer is not accessible by another customer. IMS 728 may be configured to provide various security-related services such as identity services, such as information access management, authentication and authorization services, services for managing customer identities and roles and related capabilities, and the like.

FIG. 8 illustrates an example of computer system 800. In some examples, computer system 800 may be used to implement any of the digital assistant or chatbot systems within a distributed environment, and various servers and computer systems described above. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including computer-readable storage media 822 and a system memory 810.

Bus subsystem 802 provides a mechanism for letting the various components and subsystems of computer system 800 communicate with each other as intended. Although bus subsystem 802 is shown schematically as a single bus, alternative examples of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P886.1 standard, and the like.

Processing subsystem 804 controls the operation of computer system 800 and may include one or more processors, application specific integrated circuits (ASICs), or field programmable gate arrays (FPGAs). The processors may include be single core or multicore processors. The processing resources of computer system 800 may be organized into one or more processing units 832, 834, etc. A processing unit may include one or more processors, one or more cores from the same or different processors, a combination of cores and processors, or other combinations of cores and processors. In some examples, processing subsystem 804 may include one or more special purpose co-processors such as graphics processors, digital signal processors

(DSPs), or the like. In some examples, some or all of the processing units of processing subsystem 804 may be implemented using customized circuits, such as application specific integrated circuits (ASICs), or field programmable gate arrays (FPGAs).

In some examples, the processing units in processing subsystem 804 may execute instructions stored in system memory 810 or on computer-readable storage media 822. In various examples, the processing units may execute a variety of programs or code instructions and may maintain multiple concurrently executing programs or processes. At any given time, some or all of the program code to be executed may be resident in system memory 810 and/or on computer-readable storage media 822 including potentially on one or more storage devices. Through suitable programming, processing subsystem 804 may provide various functionalities described above. In instances where computer system 800 is executing one or more virtual machines, one or more processing units may be allocated to each virtual machine.

In certain examples, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some examples. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide authentication in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 822 may store programming and data constructs that provide the functionality of some examples. Computer-readable storage media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, DVD, a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 818 may also include a computer-readable storage media reader 820 that may further be connected to computer-readable storage media 822. The computer-readable storage media reader 820 may receive and be configured to read data from a memory device such as a disk, a flash drive, etc.

In certain examples, computer system 800 may support virtualization technologies, including but not limited to virtualization of processing and memory resources. For example, computer system 800 may provide support for executing one or more virtual machines. In certain examples, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices.

Communication subsystem 824 may support both wired and/or wireless communication protocols. In certain examples, communications subsystem 824 may include radio frequency (RF) transceiver components for accessing wireless voice and/or data networks (e.g., using cellular telephone technology), advanced data network technology, such as 3G, 4G, 5G, or EDGE (enhanced data rates for global evolution), WiFi (IEEE 1002.XX family standards, or other mobile communication technologies, or any combination thereof), global positioning system (GPS) receiver components, and/or other components. In some examples, communications subsystem 824 may provide wired network connectivity (e.g., Ethernet) in addition to or instead of a wireless interface.

Communication subsystem 824 may receive and transmit data in various forms. In some examples, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, it should be appreciated that there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to related art techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods may be performed by a combination of hardware and software.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “including,” “having,” “including,” and “containing” are to be construed as open-ended terms (i.e., meaning “including, but not limited to,”) unless otherwise noted. The term “connected” is to be construed as a partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage may be from 0 to 10 percent, as a non-limiting example.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
configuring a machine learning (ML) model to be associated with a set of parameters, for monitoring a suspicious event of a plurality of suspicious events, the ML model comprising a Bayesian network (BN) constructed as a tree structure comprising nodes, each node being respectively associated with a parameter of the set of parameters and comprising a set of values corresponding to the parameter, wherein at least some parameters of the set of parameters respectively correspond to red flags;
capturing data associated with interactions of a set of customers included in a segment;
identifying, based on a plurality of rules, the suspicious event associated with a focal entity corresponding to at least one customer of the segment, wherein the suspicious event is indicative that the focal entity potentially violated a rule of the plurality of rules;
inputting event data corresponding to the suspicious event to the ML model;
outputting by the ML model an output result comprising (1) a probability prediction with respect to the focal entity being involved in the suspicious event, (2) a probability with which the focal entity violated each of one or more red flags that the rule is configured to detect among the red flags, and (3) a description of an activity that caused a violation of the one or more red flags, with respect to the focal entity;
in response to the output result, detecting a signal corresponding to a user input provided by a user through a user interface; and
in response to the signal, updating the ML model, the updating comprising updating at least one value of the set of values associated with at least one parameter of the at least some parameters, the at least one parameter being associated with the one or more red flags.

2. The computer-implemented method of claim 1, wherein the ML model is a probabilistic graph model.

3. The computer-implemented method of claim 1, wherein the outputting comprises displaying a report on a display of a user device, for the user to identify that an update of the ML model is to be performed.

4. The computer-implemented method of claim 1, wherein a plurality of ML models is configured, each of the plurality of ML models being configured to monitor for a certain suspicious event among the plurality of suspicious events, the ML model being one of the plurality of ML models.

5. The computer-implemented method of claim 4, wherein each ML model of the plurality of ML models is configured as a BN constructed as a tree structure of a certain architecture comprising nodes associated with a certain set of parameters particular to each ML model, to monitor the certain suspicious event among the plurality of suspicious events.

6. The computer-implemented method of claim 5, wherein each node of each ML model stores a set of values associated with the certain set of parameters.

7. The computer-implemented method of claim 1, wherein the ML model is continually updated.

8. A system comprising:
one or more processors; and
one or more computer-readable media storing instructions that, when executed by the one or more processors, cause the system to perform a method including:
configuring a machine learning (ML) model to be associated with a set of parameters, for monitoring a suspicious event of a plurality of suspicious events, the ML model comprising a Bayesian network (BN) constructed as a tree structure comprising nodes, each node being respectively associated with a parameter of the set of parameters and comprising a set of values corresponding to the parameter, wherein at least some parameters of the set of parameters respectively correspond to red flags;
capturing data associated with interactions of a set of customers included in a segment;
identifying, based on a plurality of rules, the suspicious event associated with a focal entity corresponding to at least one customer of the segment, wherein the suspicious event is indicative that the focal entity potentially violated a rule of the plurality of rules;
inputting event data corresponding to the suspicious event to the ML model;
outputting by the ML model an output result comprising (1) a probability prediction with respect to the focal entity being involved in the suspicious event, (2) a probability with which the focal entity violated each of one or more red flags that the rule is configured to detect among the red flags, and (3) a description of an activity that caused a violation of the one or more red flags, with respect to the focal entity;
in response to the output result, detecting a signal corresponding to a user input provided by a user through a user interface; and
in response to the signal, updating the ML model, the updating comprising updating at least one value of the set of values associated with at least one parameter of the at least some parameters, the at least one parameter being associated with the one or more red flags.

9. The system of claim 8, wherein the ML model is a probabilistic graph model.

10. The system of claim 8, wherein the outputting includes displaying a report on a display of a user device, for the user to identify that an update of the ML model is to be performed.

11. The system of claim 8, wherein a plurality of ML models is configured, each of the plurality of ML models being configured to monitor for a certain suspicious event among the plurality of suspicious events, the ML model being one of the plurality of ML models.

12. The system of claim 11, wherein each ML model of the plurality of ML models is configured as a BN constructed as a tree structure of a certain architecture comprising nodes associated with a certain set of parameters particular to each ML model, to monitor the certain suspicious event among the plurality of suspicious events.

13. The system of claim 12, wherein each node of each ML model stores a set of values associated with the certain set of parameters.

14. The system of claim 8, wherein the ML model is continually updated.

15. One or more non-transitory computer-readable media storing instructions that, when executed by one or more processors, cause the one or more processors to perform a method including:
configuring a machine learning (ML) model to be associated with a set of parameters, for monitoring a suspicious event of a plurality of suspicious events, the ML model comprising a Bayesian network (BN) constructed as a tree structure comprising nodes, each node being respectively associated with a parameter of the set of parameters and comprising a set of values corresponding to the parameter, wherein at least some parameters of the set of parameters respectively correspond to red flags;
capturing data associated with interactions of a set of customers included in a segment;
identifying, based on a plurality of rules, the suspicious event associated with a focal entity corresponding to at least one customer of the segment, wherein the suspicious event is indicative that the focal entity potentially violated a rule of the plurality of rules;
inputting event data corresponding to the suspicious event to the ML model;
outputting by the ML model an output result comprising (1) a probability prediction with respect to the focal entity being involved in the suspicious event, (2) a probability with which the focal entity violated each of one or more red flags that the rule is configured to detect among the red flags, and (3) a description of an activity that caused a violation of the one or more red flags, with respect to the focal entity;
in response to the output result, detecting a signal corresponding to a user input provided by a user through a user interface; and
in response to the signal, updating the ML model, the updating comprising updating at least one value of the set of values associated with at least one parameter of the at least some parameters, the at least one parameter being associated with the one or more red flags.

16. The one or more non-transitory computer-readable media of claim 15, wherein the ML model is a probabilistic graph model.

17. The one or more non-transitory computer-readable media of claim 15, wherein the outputting includes displaying a report on a display of a user device, for the user to identify that an update of the ML model is to be performed.

18. The one or more non-transitory computer-readable media of claim 15, wherein a plurality of ML models is configured, each of the plurality of ML models being configured to monitor for a certain suspicious event among the plurality of suspicious events, the ML model being one of the plurality of ML models.

19. The one or more non-transitory computer-readable media of claim 18, wherein each ML model of the plurality of ML models is configured as a BN constructed as a tree structure of a certain architecture comprising nodes associated with a certain set of parameters particular to each ML model, to monitor the certain suspicious event among the plurality of suspicious events.

20. The one or more non-transitory computer-readable media of claim 19, wherein each node of each ML model stores a set of values associated with the certain set of parameters.
